(19) United States
(12) Patent Application Publication
(10) Pub. No.: US 2006/0070847 A1
(43) Pub. Date: Apr. 6, 2006

(54) Apparatus for charging and removing load carriers or piece goods

(76) Inventors: Axel Besch, Wiesbaden (DE); Heiko Suess, Graz (AT)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/234,699

(22) Filed: Sep. 23, 2005

(30) Foreign Application Priority Data
Sep. 24, 2004 (DE) 10 2004 046 439.1

(51) Int. Cl. B65G 1/00

(52) U.S. Cl. 198/347.4

(57) ABSTRACT

The invention relates to an apparatus for charging and/or removing load carriers or piece goods onto or from buffer sections, such as sloping roller tracks or continuous channels, by means of a transfer apparatus for picking up in each case one load carrier or item of piece goods from a conveyor track and discharging it to a fixed buffer section, or for accepting a load carrier or item of piece goods from a buffer section in order to pass it on to a fixed discharge location. In order to achieve the object of providing an economic, simple and functional charging and/or removal apparatus, it is proposed to construct the transfer apparatus as a mobile carriage which can be positioned below the transport plane of the conveyor track or the buffer section and has a transfer element arranged thereon, and to configure the mobile carriage such that it can be moved transversely with respect to the buffer sections into positions in which it corresponds with one of the buffer sections in each case.

### BACKGROUND AND FIELD OF THE INVENTION

The invention relates to an apparatus for charging and/or removing load carriers or piece goods onto or from buffer sections, such as sloping roller tracks or continuous channels, by means of a transfer apparatus for picking up in each case one load carrier or item of piece goods from a conveyor track and discharging it to a fixed buffer section, or for accepting a load carrier or item of piece goods from a buffer section in order to pass it on to a fixed discharge location.

The withdrawal or removal of load carriers or piece goods from driven or passive buffer sections, such as continuous channels or sloping roller tracks, in order to transfer the load buffered there to a haul-off belt at the end of the buffer section is normally carried out with devices of which in each case one is assigned to each continuous channel or each sloping roller track. For example, unblocking devices similar to an opening barrier or removal devices in the form of actively driven, at least last rollers of the buffer section are usual. These devices, because they have to be assigned to each buffer section, are a large cost factor. The same applies to the charging side of the buffer section; there too a charging element has to be provided for each buffer section, that is to say for each continuous channel or for each sloping roller track, which charging element is normally constructed in the form of a pusher or the like. In order to simplify the charging and removal of the load, mobile carriages have already been proposed, which are equipped with pushers or belts and which correspond with the buffer sections.

It is desired to simplify the known apparatuses described previously for charging and/or removing load carriers or piece goods and, in particular, to minimize the high costs which arise from the fact that each individual buffer section must be assigned the same number of elements for the withdrawal or removal of the loads.

### SUMMARY OF THE INVENTION

The present invention is based on the object of providing an economic, simple and functional charging and/or removal apparatus.

According to an aspect of the invention, it is proposed to configure the charging and/or removal apparatus of load carriers or piece goods with a transfer apparatus for picking up the load from the buffer section or discharging it to the buffer section in such a way that the transfer apparatus is constructed as a mobile carriage which can be positioned below the transport plane of the conveyor track or the buffer section and has a transfer element arranged thereon, and the mobile carriage can be moved transversely with respect to the buffer sections into positions in which it corresponds with one of the buffer sections in each case. A substantially lower number of transfer apparatuses for the load are needed, since the transfer apparatus is arranged on the mobile carriage and can be moved to the respective location of the charging and/or removal as required. Depending on the capacity of the installation, there can be a single mobile carriage or a plurality of mobile carriages, which each serve a plurality of buffer sections.

According to an aspect of the invention, the transfer element on the mobile carriage is constructed as a transverse conveyor, whose conveying direction corresponds to the transport direction of the sloping roller track or of the continuous channel.

According to another aspect of the invention, provision is made for it to be possible to raise and lower the transfer element mechanically or under pressure-medium operation. In this way, the mobile carriage can be moved freely below the transport plane, while the transverse conveyor can be raised underneath the load to the charging and/or removal position, in order to lift said load off the conveyor track or set it down on the latter when the charging or removal operation is being carried out.

The transverse conveyor is constructed as a roller conveyor in one embodiment, but it is likewise also possible to construct the transverse conveyor as a chain or belt conveyor and also as a combination between a roller and a belt conveyor.

In order to save additional apparatuses, such as pushers or the like, provision is made that the conveyor itself can be driven. For this purpose, the chains, belt or rollers are driven so as to circulate in a suitable way as soon as the mobile carriage having the transfer element has been positioned in the position opposite one of the buffer sections and the load is to be picked up or discharged.

In the case in which chains or belts are used, according to a further feature of the invention, provision is made for the driven transverse conveyor to be provided with at least one drive, arranged on the chain or the belt, for the load carrier or the item of piece goods, which engages behind the load carrier or the item of piece goods as the chain or the belt circulates in the removal direction. Driver fingers are conceivable which, during the transport of the load, projecting vertically from the chain or belt, are placed behind the rear edge of the load in the transport direction and drive the load forward. At the same time, the mobile carriage can be provided with a stop for the load which can be raised and lowered, in order to stop the latter on the feed conveyor in a suitable way, in order subsequently to move the load onto the buffer section with the aid of the driver finger.

If the buffer section, as provided by another feature of the invention, is constructed as a sloping roller track, then this is arranged to be inclined at an appropriate angle, which makes an additional drive for the buffer section dispensable. If the buffer section is constructed as a continuous channel with roller track inclined in the passage direction, it is also true that an additional drive is in principle not required. Continuous channels without inclined roller track are, on the other hand, equipped with conventional drives.

In order to achieve reliable loading and unloading of the mobile carriage or the transfer element from or to the buffer section, according to yet another feature of the invention, provision is made for the mobile carriage and/or the transfer element to reach at least to some extent under the rollers arranged on the removal side of the buffer section.

In order to ensure secure transfer of the load onto the buffer section or from the buffer section, according to a further feature of the invention provision is made for it to be possible for at least one of the rollers arranged on the removal side and/or charging side of the buffer section to be driven. When use is made of a continuous channel with non-driven rollers, the driven rollers in the transfer or acceptance region ensure the necessary transport drive for the load from and to the transfer element.

The drives for the rollers arranged on the charging and/or removal side of the buffer section can be provided on the mobile carriage itself and can be brought into use only when the mobile carriage is opposite the buffer section. For instance, frictional rollers can be used for this purpose which are mounted on the mobile carriage such that they can be driven and which are brought into engagement with the roller or rollers of the buffer section or with a stationary belt, by which the rollers can be driven. It is also conceivable to use inductive drives which are fed from a power source provided on the mobile carriage as soon as the mobile carriage has been stopped in the appropriate position.

In the event that sloping roller tracks are used, an active or passive blocking element for holding the load carrier or item of piece goods back temporarily may be arranged on the removal side at the end of the buffer section. This blocking element holds the load transported to the end of the buffer section as a result of gravity firmly there until a mobile carriage with transfer element has arrived in the acceptance position.

According to another aspect of the invention, the load carrier or the item of piece goods can be lifted over the passive blocking element by the transfer element itself that can be raised and lowered and can be accepted on the mobile carriage; according to another feature of the invention, however, it is also conceivable to use an active blocking element of a known design which, according to the invention, is actuated by the transfer element itself that can be raised or lowered. The latter ensures that the blocking element is removed only when the transfer element or the mobile carriage has arrived in the acceptance position.

The mobile carriage can be moved on rails arranged transversely with respect to the buffer sections in a rack system and can be coupled to output conveyor tracks. However, according to a feature of the invention, it is also conceivable for the mobile carriage to be constructed as a satellite vehicle which can move freely in at least one of the storage levels of a rack store and on which vehicle the transfer element is arranged and which accepts the load carrier or the item of piece goods from the buffer section and transports it to any desired removal position, if appropriate even outside the storage system.

The features of the present invention result in considerable cost advantages, since a mobile carriage with transfer element which serves a large number of buffer sections is more beneficial than equipping each individual buffer section with an active withdrawal and/or removal apparatus. Since the transfer elements control the movement of the load exactly between conveyor and buffer section and also buffer section and discharge location, movement errors as a result of rotation of the load are largely ruled out. The use of the transverse conveyor that can be raised and lowered permits the transfer to cost-effective divided belt conveyors, which can be seen as a further advantage.

These and other objects, advantages, purposes and features of the invention will become apparent upon review of the following specification in conjunction with the drawings.

### BRIEF DESCRIPTION OF THE DRAWINGS

FIG. 1 is a top plan view of an apparatus according to the present invention in a storage system having buffer sections;

FIG. 2 is a side elevational view of the storage system of FIG. 1,

FIG. 3 is a top plan view of a storage system having roller conveyors and belt transfer;

FIG. 4 is a side elevational view of the system of FIG. 3;

FIG. 5 is a side elevational view illustrating the drive of individual rollers by means of a friction wheel;

FIG. 6 is a top plan view of a storage system having a mobile carriage constructed as a satellite vehicle;

FIG. 7 is a side elevational view of a transfer element for transferring a load, having belt conveyor and drivers; and

FIG. 8 is a side elevational view of a transfer element for accepting a load, having belt conveyor and drivers.

### DESCRIPTION OF THE PREFERRED EMBODIMENTS

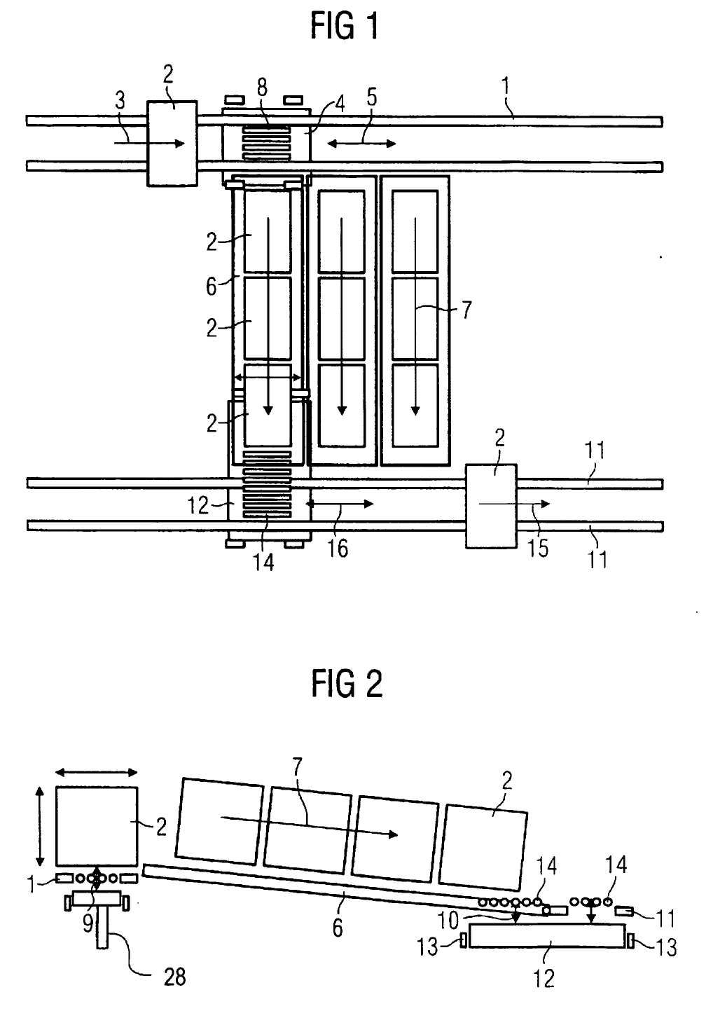

In FIG. 1, a feed conveyor in the form of a belt or chain conveyor is designated 1, on which the load 2, which can be a piece of goods itself or a load carrier, is conveyed up in the transport direction 3. Below the level of the feed conveyor 1, the mobile carriage 4 is arranged such that it can be moved freely in both transport directions 5 and, in the illustration of FIG. 1, has been stopped in a position in which the mobile carriage 4 is located opposite one of the buffer sections 6. This buffer section in the present example is intended to represent a sloping roller track, on which a number of loads 2 have already been buffeted. The buffer section 6 is inclined in the direction of arrow 7, such that, following the transfer from the mobile carriage 4 onto the buffer section, the loads 2 move downward as a result of gravity.

On the mobile carriage 4, the transfer element 8 is arranged in the form of a transverse conveyor, which is constructed as a roller conveyor. As illustrated in FIG. 2, transfer element 8 can be raised and lowered in the direction of arrow 9 by a lifter 28, where the lifter 28 may be, for example, a mechanical lifter or a pressure-medium lifter, such as a hydraulic cylinder or a gas cylinder. While the transfer element 8 is positioned in the transport position 5 of the mobile carriage 4 below the transport plane of the feed conveyor 1 formed by the belts or chains, so that the mobile carriage 4 can also be moved through underneath loads 2 resting thereon, the transfer element 8 is raised with respect to the buffer section 6 after it has been positioned, so that it comes above the transport plane of the feed conveyor section 1. In this position, the rollers of the transfer element 8, which are driven in the present example, effect transport of the load 2 in the direction of the buffer section 6 and transfer the load 2 to the same. The load 2 is moved downward in the passage direction of arrow 7 on the sloping roller track of the buffer section 6 until it is stopped by a blocking element, which is provided at the lower end of the buffer section. The blocking element can be raised and lowered in order to release or hold firmly a load for transfer to a further mobile carriage with transfer element. This mobile carriage can likewise be moved underneath the belt or chain conveyor 11 provided on the removal side at the end of the buffer track 6, in the same way as the carriage 4 underneath the feed conveyor 1 at the upper end of the buffer section. The mobile carriage, designated overall by 12, which can be moved on wheels 13 on rails, not illustrated (at right angles to the plane of the drawing), carries a transfer element according to the invention in the form of the transverse conveyor 14, which can likewise be raised and lowered from a position below the transport plane of the conveyor 11 into a position above this plane, it being possible in the latter position for the load 2 lifted off the roller conveyor section 10 to be transferred onto the transverse conveyor 14. For the purpose of assistance, at least the last rollers of the buffer section 6 can be driven, in order to ensure trouble-free transfer of the load 2 onto the transverse conveyor 14. By means of lowering the transverse conveyor 14, the load 2 resting thereon is likewise lowered, fed to the transport belts or the chains of the conveyor 11 and transported away in the direction of arrow 15 (FIG. 1).

The mobile carriages 4 and 12 can be moved in the direction of arrow 5 and 16, respectively, into the predetermined position, where the load 2 is to be transferred to the buffer section or accepted from the buffer section. In this case, each of the two mobile carriages, in the lowered position of their transfer elements 8 and 14, respectively, can also be moved through under a load 2 resting on the feed conveyor 1 or the output conveyor 11 in order as a result to arrive quickly and flexibly in the required acceptance or transfer position.

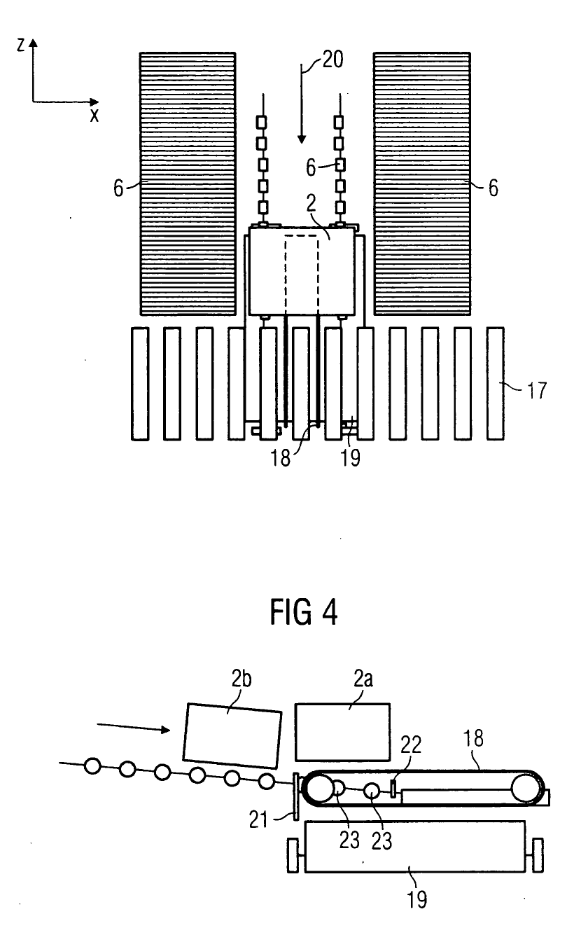

In FIG. 3, another apparatus according to the invention is illustrated, here only the transfer element 8 at the end of the buffer section 6 being shown. The output conveyor 17 is a roller conveyor, while the transverse conveyor of the transfer apparatus 8 on the mobile carriage 19 is constructed as a belt conveyor. The buffer sections 6 are constructed as non-driven roller tracks, as is symbolized by the central buffer section, on which tracks the load 2 is transported in the direction of arrow 20 as a result of gravity.

As can be seen in FIG. 4, the side view of the illustration in FIG. 3, two blocking elements 21, 22 are provided, which are used for the proper transfer of the load 2. As long as no mobile carriage is positioned in the acceptance position, the load 2b is held back by the blocking element 22. In the acceptance position, the mobile carriage travels underneath the last rollers of the buffer section 6; in this position the transverse conveyor, which is constructed here as a belt conveyor having belts 18, is raised into the upper position illustrated. At the same time, the load 2b is held back on the rollers of the buffer section 6 by the blocking element 21, so that the transverse conveyor 14 can be raised into the position illustrated, in which the loadbearing part of the belt 18 of the belt conveyor is positioned above the blocking element 22.

If this belt 18 is then driven (not illustrated here), then the load 2a is transported over the blocking element 22 into a position above the rollers of the roller conveyor 17 and, by lowering the transverse conveyor 14, is set down on the latter. The mobile carriage 19 is now ready for a further transfer/acceptance cycle and can be moved into the desired position opposite another buffer section 6.

In FIG. 5, it is shown schematically how the drive, provided in accordance with a feature of the invention, of the last rollers of the buffer section 6 can be carried out in order to transfer the load 2. For this purpose, a friction wheel drive 25 is provided on the carriage 24 and can be brought into contact with at least one of the rollers of the conveyor by being raised. The driven rollers 23 transport the load onto the roller conveyor 17.

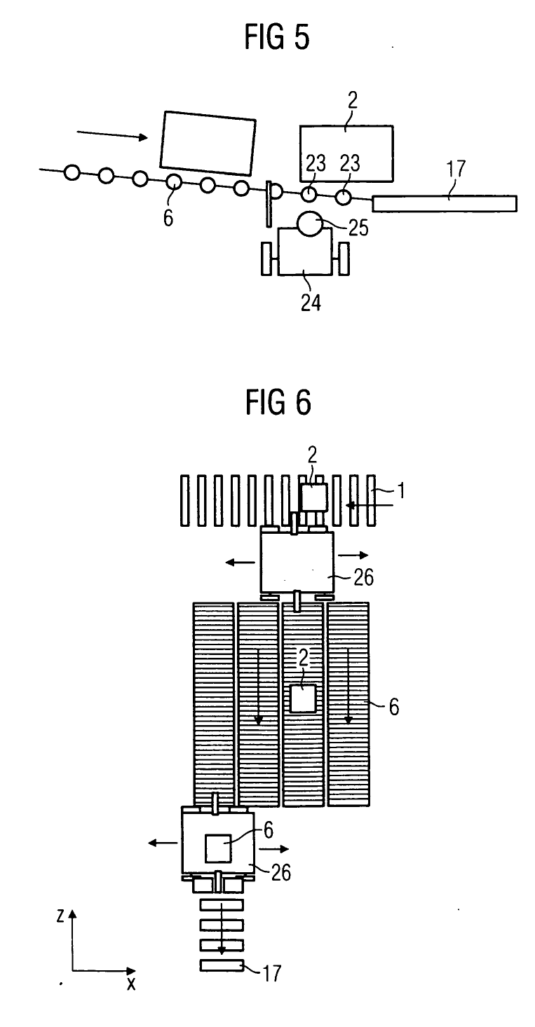

FIG. 6 illustrates schematically in a plan view of a storage system that the mobile carriage can be constructed as a satellite vehicle (shuttle) 26, here, too, the transfer elements being carried along on this shuttle vehicle and being able to reach into the region of the feed or output conveyor in order to pick up or discharge the load. The shuttle vehicles 26 can move freely in the storage system and, if necessary, can also move out of the latter to defined transfer positions.

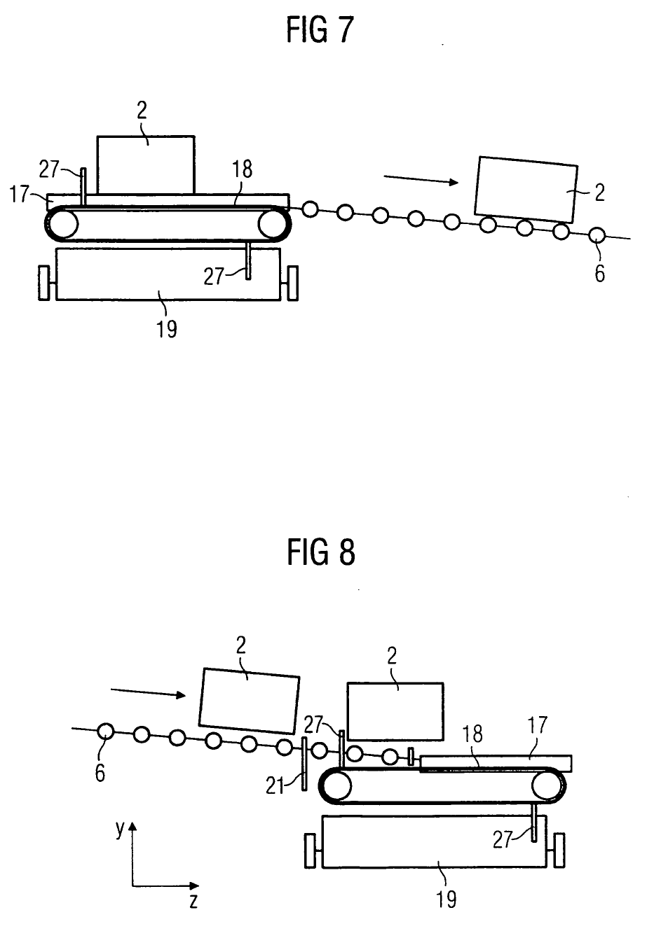

FIG. 7 shows a solution in which the transfer element 8 is constructed as a belt conveyor, whose belts 18, which can be raised and lowered, reach through the rollers 17 of the feed conveyor 1, constructed as a roller conveyor, in order to accept the load 2. In order to transfer the load 2 from the transfer element 8 to the buffer section 6, two drivers 27 projecting vertically are fixed to the belt 18 of the belt conveyor, engage behind the load 2 and transport the latter in the direction of circulation of the belt conveyor in the direction of the buffer section 6.

FIG. 8 shows an identical belt conveyor as a transfer element 8 on a mobile carriage 19 at the other end of the buffer section 6. Here, too, use is made of a belt conveyor, which reaches through the rollers 17 of the output conveyor 11 with the belts 18, engages behind the load 2 with one of the two drivers 27 arranged on the belt 18 and transfers said load 2 from the buffer section 6 onto the mobile carriage 19, where it can be transported away after being lowered onto the rollers 17 of the output conveyor 11.

Changes and modifications in the specifically described embodiments can be carried out without departing from the principles of the present invention, which is intended to be limited only by the scope of the appended claims, as interpreted according to the principles of patent law including the doctrine of equivalents.

1. An apparatus for charging and/or removing load carriers or piece goods onto or from buffer sections by a transfer apparatus, said transfer apparatus being adapted to pick up in each case one load carrier or item of piece goods from a conveyor track and discharge it to a fixed buffer section, or accept a load carrier or item of piece goods from a buffer section in order to pass it on to a fixed discharge location, wherein said transfer apparatus comprises a mobile carriage having a transfer element, said mobile carriage adapted to being positioned below the transport plane of the conveyor track or the buffer section, and wherein said mobile carriage is movable transversely with respect to the buffer sections into positions corresponding with one of the buffer sections in each case.

2. The apparatus of claim 1, wherein said transfer element comprises a transverse conveyor.

3. The apparatus of claim 1, wherein said transfer element is adapted to be selectively raised and lowered by at least one lifter, wherein said at least one lifter comprises at least one selected from the group consisting of a mechanical lifter and a pressure-medium lifter.

4. The apparatus of claim 1, wherein said transfer element is adapted to be driven.

5. The apparatus of claim 2, wherein said transfer element comprises a roller conveyor.

6. The apparatus of claim 2, wherein said transfer element comprises at least one selected from the group consisting of a chain conveyor, a belt conveyor, and a combined roller and belt conveyor.

7. The apparatus of claim 6, wherein said transfer element is provided with at least one driver, said at least one driver being adapted to engage behind the load carrier or the item of piece goods as said transfer element circulates in the removal direction, and wherein said at least one driver is arranged on at least one selected from the group consisting of said chain conveyor, said belt conveyor, and a belt of said combined roller and belt conveyor.

8. The apparatus of claim 1, wherein said buffer section comprises a sloping roller track.

9. The apparatus of claims 1, wherein said buffer section comprises a continuous channel with roller track inclined in the passage direction.

10. The apparatus of claim 1, further comprising at least one roller arranged on the removal side of said buffer section, and wherein at least one selected from the group consisting of said mobile carriage and said transfer element reaches at least to some extent under said at least one roller.

11. The apparatus of claim 10, wherein at least one of said at least one rollers arranged on the removal side of said buffer section is a driven roller, said at least one driven roller being adapted to be driven in the direction of said mobile carriage.

12. The apparatus of claim 11, wherein said mobile carriage further includes a friction wheel drive, said friction wheel drive being adapted to selectively drive said at least one driven roller arranged on the removal side of the buffer section when said friction wheel drive engages stationary drives of said at least one roller.

13. The apparatus of claim 1, further including a blocking element arranged at the end on the removal side of the buffer section, said blocking element being adapted to hold the load carrier or item of piece goods back temporarily.

14. The apparatus of claim 3, further including a blocking element arranged at the end on the removal side of the buffer section, said blocking element being adapted to hold the load carrier or item of piece goods back temporarily.

15. The apparatus of claim 14, wherein said blocking element comprises a passive blocking element, and wherein said load carrier or the item of piece goods can be lifted over said passive blocking element by said transfer element.

16. The apparatus of claim 14, wherein said blocking element comprises an active blocking element, and wherein said active blocking element is adapted to be actuated by said transfer element.

17. The apparatus of claim 1, wherein said mobile carriage comprises a shuttle vehicle, said shuttle vehicle being adapted to move freely in at least one of the storage levels of a rack store, said transfer element being arranged on said shuttle vehicle and adapted to accept the load carrier or the item of piece goods from the buffer section.

18. An apparatus for charging and/or removing load carriers or piece goods onto or from buffer sections by a transfer apparatus, said transfer apparatus being adapted to pick up in each case one load carrier or item of piece goods from a conveyor track and discharge it to a fixed buffer section, or accept a load carrier or item of piece goods from a buffer section in order to pass it on to a fixed discharge location;
wherein said transfer apparatus comprises a mobile carriage having a transfer element, said mobile carriage adapted to being positioned below the transport plane of the conveyor track or the buffer section, said mobile carriage being movable transversely with respect to the buffer sections into positions corresponding with one of the buffer sections in each case;
and wherein said transfer element comprises a transverse conveyor, said transverse conveyor adapted to being driven and to being selectively raised and lowered by at least one lifter, wherein said at least one lifter comprises at least one selected from the group consisting of a mechanical lifter and a pressure-medium lifter.

19. The apparatus of claim 18, wherein said transfer element comprises a roller conveyor.

20. The apparatus of claim 18, wherein said transfer element comprises at least one selected from the group consisting of a chain conveyor, a belt conveyor, and a combined roller and belt conveyor.

21. The apparatus of claim 20, wherein said transfer element is provided with at least one driver, said at least one driver being adapted to engage behind the load carrier or the item of piece goods as said transfer element circulates in the removal direction, and wherein said at least one driver is arranged on at least one selected from the group consisting of said chain conveyor, said belt conveyor, and a belt of said combined roller and belt conveyor.

22. The apparatus of claim 18, further comprising at least one roller arranged on the removal side of said buffer section, and wherein at least one selected from the group consisting of said mobile carriage and said transfer element reaches at least to some extent under said at least one roller, and wherein at least one of said at least one rollers is a driven roller, said at least one driven roller being adapted to be driven in the direction of said mobile carriage.

23. The apparatus of claim 22, wherein said mobile carriage further includes a friction wheel drive, said friction wheel drive being adapted to selectively drive said at least one driven roller arranged on the removal side of the buffer section when said friction wheel drive engages stationary drives of said at least one roller.

24. The apparatus of claim 18, further including a blocking element arranged at the end on the removal side of the buffer section, said blocking element being adapted to hold the load carrier or item of piece goods back temporarily.
